(19) United States
(12) Patent Application Publication
(10) Pub. No.: US 2008/0037572 A1
(43) Pub. Date: Feb. 14, 2008

(54) Differentiated Services Code Point and Logical Channels

(75) Inventors: Benoist Sebire, Beijing (CN); Tatikonda Sivakumar, Tokyo (JP); Haitao Tang, Helsinki (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/619,377

(22) Filed: Jan. 3, 2007

Related U.S. Application Data
(60) Provisional application No. 60/755,094, filed on Jan. 3, 2006.

(51) Int. Cl. H04L 12/56

(52) U.S. Cl. 370/412

(57) ABSTRACT

Provided are apparatuses and methods for determining a logical channel for transmission of a data packet in a network. A logical channel may provide a corresponding Quality of Service (QoS). Data traffic may be identified based on class of service (CoS) and each CoS may be handled through a default QoS configuration, for example. A logical channel may be associated with or preconfigured with a designated default QoS configuration such that transmission of data on the logical channel may be available without prior QoS negotiation or setup signaling. In one example, the selection of the logical channel may be based on a Differentiated Services Code Point (DSCP) marked in the data packet.

### CROSS REFERENCE TO RELATED APPLICATIONS

This application claims the benefit of U.S. Provisional Application No. 60/755,094, filed on Jan. 3, 2006, and which is incorporated herein by reference.

### TECHNICAL FIELD

The invention relates generally to communications networks. More specifically, the invention provides for coordination of logical channels in a communication network.

### BACKGROUND

End-to-end Quality of Service (QoS) describes the ability of a network to provide service as required by a particular type of network traffic. The service is provided from one end of the network to another. Differentiated Services (DiffServ) describes one type of service model in end-to-end QoS provisioning in which differing QoS requirements may be met. The network thus delivers a service of the type based on the QoS specified by each packet.

In Long Term Evolution (LTE), QoS provisioning for IP traffic uses tools standardized by the Internet Engineering Task Force (IETF). A logical channel carries information or data that may be in the same physical channel but may be separated logically from other data. In a radio access network (RAN), appropriate logical channels are selected for transmission of each packet, each logical channel providing a given QoS configuration.

Different service classes of traffic may have different QoS requirements such that classes of traffic are categorized in a respective class of service (CoS). Also, a data packet being transmitted in a logical channel with a corresponding QoS configuration may be subject to specified transmission methods or forwarding treatment such as a Differentiated Services Code Point (DSCP). For example, per-hop behavior (PHB) may vary based on the CoS and/or QoS configurations or a DSCP range at each network node in a corresponding logical channel.

There exists a need in the art for a method and system for efficiently transmitting data in a communication network in a logical channel in which the transmitted data corresponds to the logical channel or a corresponding DSCP.

### SUMMARY

The following presents a simplified summary in order to provide a basic understanding of some aspects of the invention. The summary is not an extensive overview of the invention. It is neither intended to identify key or critical elements of the invention nor to delineate the scope of the invention.

The following summary merely presents some concepts of the invention in a simplified form as a prelude to the more detailed description below.

In one example, a method is provided for selecting or determining a logical channel for data transmission, the logical channel corresponding to a Quality of Service (QoS) configuration. In another example, the logical channel may be selected based on the data packet. For example, the data packet may be marked with a Differentiated Services Code Point (DSCP) for selecting the logical channel.

In another example, a transmitter is provided for determining a logical channel or a default logical channel corresponding to a QoS. The QoS may further be indicated by the data packet which may be marked. For example, the data packet may include a bit pattern such as a DSCP for indicating a logical channel and/or a corresponding QoS for data transmission.

In another example, a receiver is provided for receiving a data transmission corresponding to a logical channel. The receiver may identify the logical channel and apply a corresponding QoS based on the identified logical channel.

In another example, a computer-readable medium is provided containing computer-executable code for identifying or selecting a logical channel for data transmission based on a data packet. For example, the logical channel may be selected based on a DSCP in a header of the data packet.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a DiffServ field in which one or more illustrative embodiments of the invention may be implemented.

FIG. 2 illutrates an example of a packet header containing a Type of Service (ToS) field in which one or more illustrative embodiments of the invention may be implemented.

FIG. 3 is a partial block diagram illustrating an example of a transmitter in which one or more illustrative embodiments of the invention may be implemented.

FIG. 4 is a partial block diagram illustrating an example of a receiver in which one or more illustrative embodiments of the invention may be implemented.

FIG. 5 is a flowchart illustrating an example of a method for determining a logical channel based on a DSCP value in a data packet in which one or more illustrative embodiments of the invention may be implemented.

FIG. 6 is a flowchart illustrating an example of selecting a logical channel in which one or more illustrative embodiments of the invention may be implemented.

FIG. 7 is a flowchart illustrating an example of copying a DSCP from an IP packet in which one or more illustrative embodiments of the invention may be implemented.

FIG. 8 is a flowchart illustrating an example of determining a logical channel based on a default range of the DSCP in which one or more illustrative embodiments of the invention may be implemented.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

Differentiated Services (DiffServ) may provide for simple or coarse methods for categorizing traffic into different classes (CoS) or to apply corresponding QoS parameters to each of the classes. For example, in a packet forwarding path, DiffServ may map a code point contained in a field in the packet header to a particular forwarding treatment (i.e., PHB) at each network node along the path of transmission. In this example, a small bit pattern such as the Differentiated Services Code Point (DSCP) in each data packet may be used to mark the data packet to receive a particular PHB at a network node. Marking may be accomplished, for example, in a DiffServ field in a data packet.

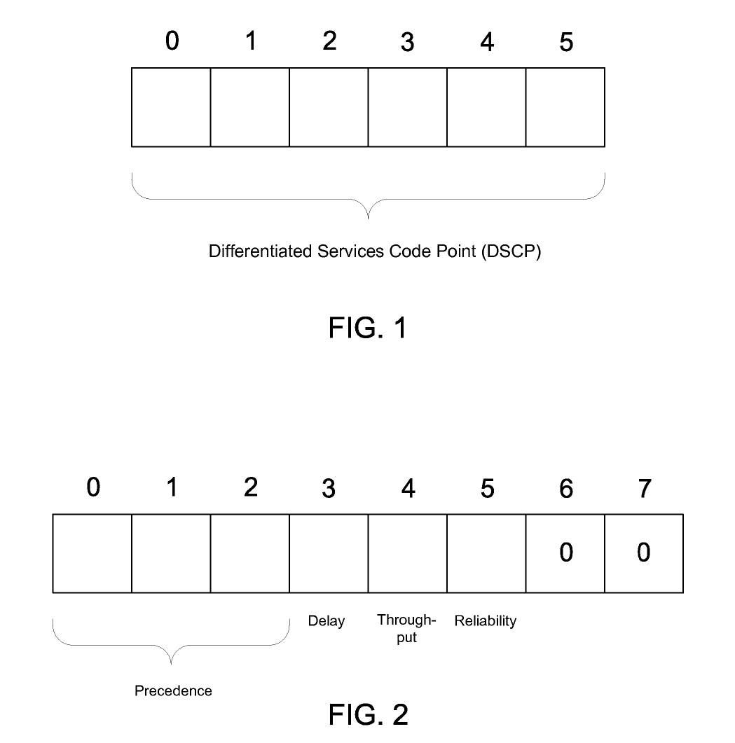

FIG. 1 illustrates an example of a DiffServ field in which six bits of the DiffServ field may be used as the DSCP to select a PHB for each packet at a particular node.

In the example illustrated in FIG. 1, the DSCP field is six bits wide with the left-most bit signifying bit 0 of the DiffServ field and the right-most bit signifying bit 5 of the DiffServ field. Thus, in this example, a DiffServ-compliant node in the network may select a PHB by matching against the 6-bit DiffServ field and selecting a particular packet handling mechanism implemented in that node or device.

In another example, the DSCP marks a packet in the IPv4 Type of Service (ToS) octet or the IPv6 Traffic Class octet to receive a particular forwarding treatment (i.e., PHB). As FIG. 2 illustrates in this example, the packet header may contain a ToS field of 8 bits to provide parameters to be used to guide the selection of actual service parameters when transmitting a datagram through a particular network. For example, a priority may be determined for a particular data traffic.

In one example, data traffic may be further classified based on delay, reliability, or throughput. As FIG. 2 illustrates, a ToS field may indicate precedence of the data packet (bits 0-2), delay (bit 3), throughput (bit 4) or reliability (bit 5).

Additional bits may be provided for additional desired parameters (e.g., bits 6-7 in FIG. 2). As examples of precedence of the data packet (bits 0-2), the precedence may be indicated as network control, internetwork control, CRITIC/ECP, Flash override, Flash, immediate, priority, or routine, to name a few.

In one example of the present invention, a logical channel may be preconfigured for a given DSCP value or set of DSCP values. The logical channel may also provide a given QoS such that the DSCP may be associated with a corresponding QoS configuration. In another example, default QoS configurations may be used for most kinds of data traffic such that setup signaling is not necessary. A default QoS configuration may be associated with a preconfigured logical channel that may be available without prior QoS negotiation or setup signaling.

In another example, a mapping is provided for the DSCP or set or range of DSCP values and a corresponding QoS configuration with an associated logical channel. For example, a DSCP range may be provided with a corresponding default QoS configuration. The default QoS configuration may be associated with a default logical channel that may provide the default QoS configuration.

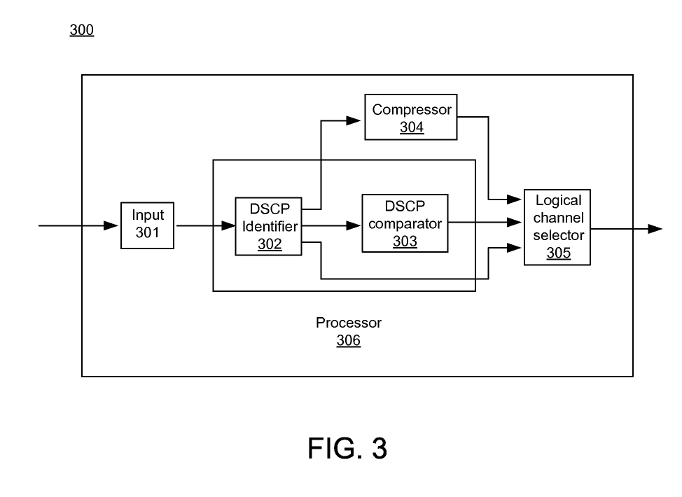

FIG. 3 is a partial block diagram illustrating an example of a transmitter of the present invention. In this example, a transmitter 300 may include an input 301 for receiving an IP data packet. The IP data packet may further include a DSCP, for example, in the header of the IP data packet. A DSCP identifier 302 may be provided in the transmitter 300 for identifying the DSCP in the received IP data packet. Based on the identified DSCP, a logical channel for transmitting data may be selected by the logical channel selector 305. For example, a DSCP comparator 303 may be provided for comparing the received DSCP associated with the IP data packet to determine if the received DSCP belongs to a default or known range. In this example, the logical channel selector 305 may select a default logical channel corresponding to the received default DSCP for transmitting data. In addition, the default logical channel may be preconfigured to provided the QoS instructed by the DSCP.

The transmitter 300 may further include a compressor 304 for compressing the IP header. In this example, the received DSCP may be identified by the DSCP identifier 302 prior to compression of the IP header. Thus, the DSCP may be copied from the original IP packet followed by compression of the IP header by the compressor. The logical channel selector 305 in this example may select the logical channel according to the received DSCP field. Alternatively, the logical channel may also be selected in a different network node based on the DSCP.

In another example, the IP data packet received at the transmitter 300 may not contain an available DSCP. The IP data packet may be received at the input 302 of the transmitter 300, however, the DSCP identifier 302 in this example does not identify a DSCP as being available. In this example, the logical channel selector 305 may select an appropriate logical channel based on alternate network layers. For example, the logical channel selector 305 may select a default preconfigured logical channel based on network layers that are higher than the IP layer. Such network layers may include, for example, UDP, TCP, RTP, FTP, HTTP, etc. Also, logical channels may be configured to support combinations of network layers, for example, a logical channel may be configured to support all UDP and RTP traffic.

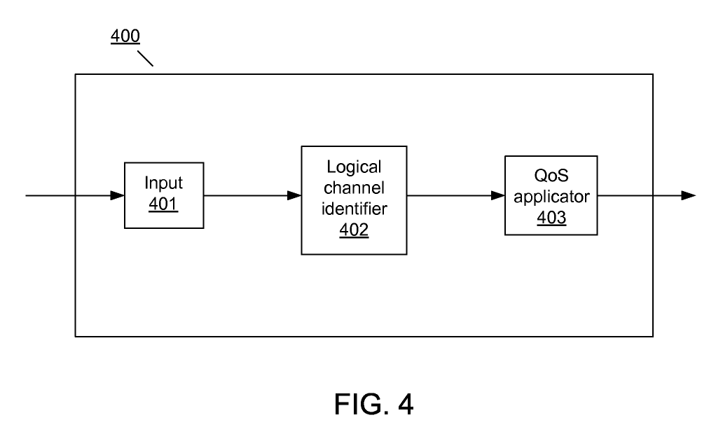

FIG. 4 is a partial block diagram illustrating an example of a receiver of the present invention. In this example, a receiver 400 may receive at an input 401 a data transmission associated with a logical channel. Also in this example, the receiver 400 includes a logical channel identifier 402 for identifying the logical channel associated with the data transmission received. The receiver 400 may also contain a QoS applicator 403 for applying an appropriate QoS to the transmission based on the identified logical channel.

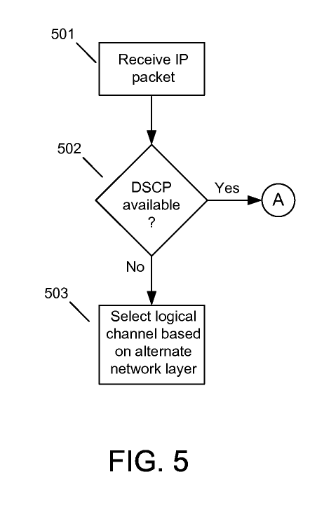

FIG. 5 illustrates an example of determining a logical channel and QoS based on a DSCP value in a data packet. In this example, an IP data packet is received at a node in a network (STEP 501). The IP packet may include a header which may contain a DSCP. If a DSCP is not available in the IP packet (the “NO” branch of STEP 502), then a logical channel is selected corresponding to the IP packet based on alternate network layers, for example, network layers higher than the IP layer (STEP 503). For example, a default preconfigured logical channel may be selected to support data traffic based on any network layer including network layers higher than IP such as User Datagram Protocol (UDP), Transmission Control Protocol (TCP), Realtime Transport Protocol (RTP), File Transfer Protocol (FTP), Hypertext Transfer Protocol (HTTP), etc. Also, the default preconfigured logical channel may be selected based on any combination of layers higher than IP. For example, one logical channel may be preconfigured to support all TCP traffic. Another logical channel may be preconfigured to support all UDP and RTP traffic, etc.

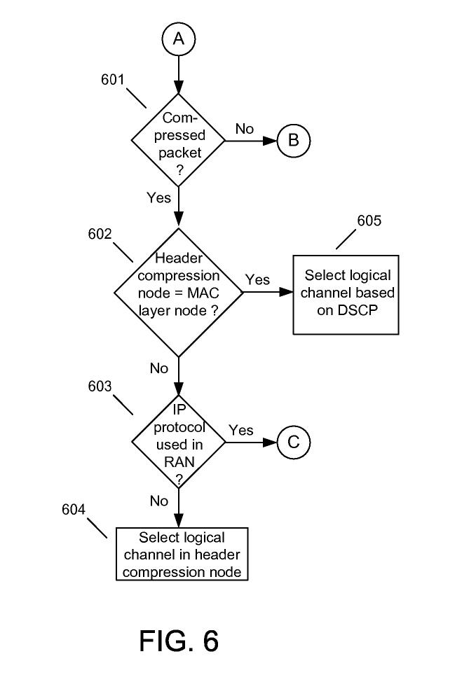

As illustrated in the example of FIG. 5, if a DSCP is available in the IP packet (the “YES” branch of STEP 502), then a logical channel may be selected corresponding to the value of DSCP. FIG. 6 illustrates an example of selecting a logical channel corresponding to a value or range of values of DSCP. In this example, compression of the IP packet may be detected (STEP 601). If the IP packet is compressed, the original IP header may not be available. This may include unavailability of the DSCP field in the original IP header. In LTE, a logical channel may be a bit-pipe provided by a Media Access Control (MAC) layer, each logical channel being set up to provide a given QoS. In this example, if compression of the header in the IP packet occurs in a node that is different from the MAC layer node (the “NO” branch of STEP 602), then QoS related information such as the DSCP field, the use of User Datagram Protocol (UDP), the use of Real-time Transport Protocol (RTP), etc., may be carried from the node where header compression occurs to the MAC layer node. Also, the logical channel may be selected in the node performing header compression (STEP 604). Selecting the logical channel in the node may be accomplished in a variety of ways. In one example, a “pipe” is selected in the node that performs header compression. A mapping may be maintained between the “pipe” and the logical channel.

Also, in another example, compression of the header in the IP packet occurs in same network node as the MAC layer node (the “YES” branch of STEP 602). In this example, DSCP information need not be carried between nodes in the network. Therefore, in this example, the logical channel may be selected according to the DSCP (STEP 605).

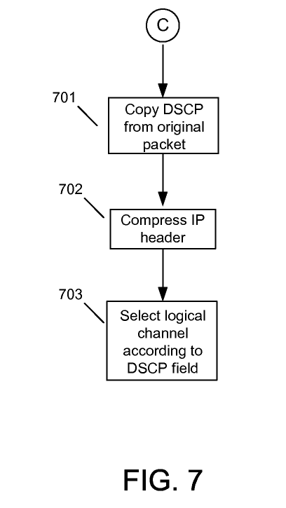

In another example, an IP protocol is used within the radio access network (RAN) (the “YES” branch of STEP 603). As illustrated in the example of FIG. 7, the DSCP in the original IP packet may be copied from the original IP packet (STEP 701). The DSCP may be copied from the original IP packet prior to the compression of the IP packet (STEP 702). Thus, the DSCP information from the original IP packet may be used to select a logical channel at a different or same node. Selection of the logical channel may be made according to the DSCP field (STEP 703). In this example, compression of the IP header (STEP 702) may occur following copying of the DSCP from the original IP packet (STEP 701).

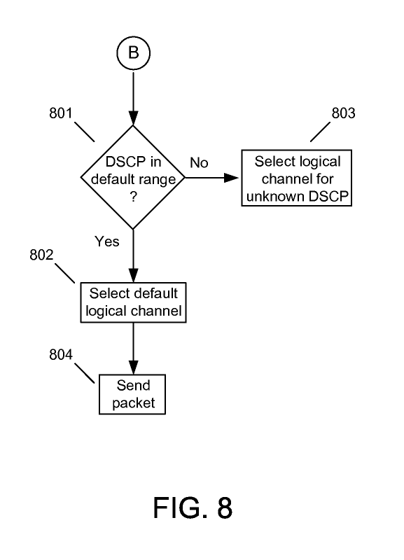

In another example, a DSCP is available (“YES” branch of STEP 502) and the packet is not compressed (“NO” branch of STEP 601). A logical channel may be selected that may correspond to the value of the DSCP. In one example illustrated in FIG. 8, the DSCP may be in a default range (“YES” branch of STEP 801) such that the IP packet may be transmitted (STEP 804) via a selected default logical channel (STEP 802) corresponding to a preconfigured default logical channel providing QoS, the QoS being instructed by DSCP. When a receiver receives the transmitted data, the logical channel may be recognized at the receiver. Based on the recognized logical channel, QoS corresponding to the recognized logical channel may be applied to the data transmission.

In another example, the DSCP is not within a default range (the “NO” branch of STEP 801). In this example, a logical channel is selected for an unknown DSCP (STEP 803). The selected logical channel in this example may be preconfigured for an unknown DSCP such that one default logical channel may be used when the DSCP does not belong to a known range or a default range. In another example, one default logical channel may be used for any DSCP of an IP packet that does not belong to a known default range. In yet another example, a set of default logical channels may be provided for use with transmission of an IP packet containing a DSCP that does not belong to a default range.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended embodiments.

We claim:

1. A method comprising:
receiving a data packet; and
selecting a logical channel based on at least a portion of the data packet.

2. The method of claim 1 wherein the at least a portion of the data packet corresponds to a Differentiated Services Code Point (DSCP).

3. The method of claim 2 wherein the selecting comprises selecting a logical channel based on the DSCP.

4. The method of claim 3 wherein the selecting comprises selecting a default logical channel corresponding to the DSCP and sending the data packet using the selected default logical channel.

5. The method of claim 4 wherein the DSCP belongs to a default range.

6. The method of claim 4 wherein the DSCP does not belong to a default range and wherein the default logical channel corresponds to unknown DSCPs.

7. The method of claim 1 wherein the selecting comprises selecting a logical channel based on a network layer higher than an IP network layer.

8. The method of claim 7 wherein the network layer is selected from the group consisting of UDP, TCP, RTP, FTP and HTTP.

9. The method of claim 1 wherein at least a portion of the data packet is compressed at a first node.

10. The method of claim 9 wherein the at least a portion of the data packet comprises a header of the data packet.

11. The method of claim 10 wherein the selecting comprises selecting the logical channel at the first node.

12. The method of claim 11 wherein the selecting further comprises selecting a pipe in the first node, the pipe having a fixed mapping to the logical channel.

13. The method of claim 10 wherein the header of the data packet comprises a DSCP and wherein the selecting comprises copying the DSCP from the data packet prior to compressing the at least a portion of the data packet at the first node.

14. The method of claim 13 wherein the selecting comprises selecting the logical channel at a second node that is different from the first node.

15. The method of claim 13 wherein the selecting comprises selecting the logical channel at the first node.

16. A method comprising:
receiving a data packet corresponding to a logical channel;
identifying the logical channel, the logical channel being associated with a Quality of Service (QoS); and
applying the QoS to the data packet.

17. The method of claim 16, wherein the logical channel is identified based on a bit pattern associated with the data packet.

18. The method of claim 17, wherein the bit pattern corresponds to a Differentiated Services Code Point (DSCP).

19. A transmitter comprising:
an input for receiving a data packet for transmission;
a DSCP identifier for identifying a DSCP in the received data packet; and
a logical channel selector for selecting a logical channel corresponding to the DSCP identified by the DSCP identifier.

20. The transmitter of claim 19 further comprising a compressor for compressing at least a portion of the data packet.

21. A receiver comprising:
an input for receiving a data packet corresponding to a logical channel;
a logical channel identifier for identifying the logical channel corresponding to the data packet; and
a QoS applicator for applying QoS corresponding to the identified logical channel to the data packet.

22. A computer-readable medium having computer-executable instructions for performing the steps of:
receiving a data packet including a DSCP; and
selecting a logical channel for transmission of the data packet based on the DSCP.

23. The computer readable medium of claim 22, wherein selecting the logical channel is further based on a network layer higher than an IP network layer.

24. The computer readable medium of claim 23, wherein the network layer is selected from a group consisting of: UDP, TCP, RTP, FTP and HTTP.

25. An apparatus comprising:
means for receiving a data packet; and
means for selecting a logical channel based on at least a portion of the data packet.

26. The apparatus of claim 25, further comprising means for applying a quality of service (QoS) corresponding to the selected logical channel.

27. The apparatus of claim 25, wherein the at least a portion of the data packet corresponds to a Differentiated Services Code Point (DSCP).
